(19) United States
(12) Patent Application Publication
(10) Pub. No.: US 2025/0106856 A1
(43) Pub. Date: Mar. 27, 2025

(54) METHOD AND DEVICE FOR MONITORING DOWNLINK CHANNEL, AND READABLE STORAGE MEDIUM

(71) Applicant: Beijing Xiaomi Mobile Software Co., Ltd., Beijing (CN)

(72) Inventor: Ting FU, Beijing (CN)

(21) Appl. No.: 18/730,871

(22) PCT Filed: Jan. 28, 2022
(86) PCT No.: PCT/CN2022/074814

§ 371 Date: Jul. 22, 2024

(51) Int. Cl. H04W 72/23; H04W 74/0833

(52) U.S. Cl. CPC H04W 72/23; H04W 74/0833

(57) ABSTRACT

A downlink channel monitoring method is performed by a user device and includes: keeping a main transceiver in an on state for a set time period after the user device sends or receives a set message, wherein the on state of the main transceiver corresponds to monitoring of a downlink channel.

### CROSS REFERENCE TO RELATED APPLICATION(S)

The present application is a U.S. National Stage of International Application No. PCT/CN2022/074814 filed on Jan. 28, 2022, the content of which is incorporated herein by reference in its entirety.

### TECHNICAL FIELD

The present disclosure relates to the field of wireless communication technology, and in particular, to a downlink channel monitoring method, device, and readable storage medium.

### BACKGROUND

In wireless communication technology, for example, in the 5th generation mobile communication technology (5G), the main transceiver may be kept in a sleep mode for saving power consumption of a user equipment (UE).

The network device may send a wake-up signal (WUS), and WUS may indicate to one or more UEs about whether to wake up for downlink monitoring. For example, WUS includes 16 bits corresponding to 16 UEs, and each bit corresponds to one UE. When the bit corresponding to a UE is 1, it indicates to wake up, and the UE turns on the main transceiver for receiving downlink signals. When the bit corresponding to a UE is 0, it indicates not to wake up, and the UE keeps the main transceiver in a sleep mode.

The state of the main transceiver of the user equipment needs to rely on the WUS signal.

### SUMMARY

The present disclosure provides a downlink channel monitoring method, device, and readable storage medium.

In a first aspect, a downlink channel monitoring method is provided, which is performed by a user device and includes:
keeping a main transceiver in an on state for a set time period after the user device sends or receives a set message, where the on state of the main transceiver corresponds to monitoring of a downlink channel.

In this method, after the user device sends or receives the set message, the main transceiver is kept in the on state for the set time period for downlink channel monitoring. Thus, the main transceiver can be turned on without the need for a wake-up signal to trigger, thereby reducing the dependence on the wake-up signal and improving the active processing capability of the user device.

In some implementations, keeping the main transceiver in the on state for the set time period after the user device sends or receives the set message, includes:
in response to the user device receiving or not receiving the wake-up information after sending or receiving the set message, keeping the main transceiver in the on state for the set time period.

In some implementations, the set time period corresponds to the set message.

In some implementations, keeping the main transceiver in the on state for the set time period after the user device sends or receives the set message, includes:
after the user device sends the set message in random access, keeping the main transceiver in the on state for the set time period, where the set time period is a first time period.

In some implementations, keeping the main transceiver in the on state for the set time period after the user device sends or receives the set message, includes:
after the user device sends the set message in four-step random access, keeping the main transceiver in the on state for the set time period, where the set message is msg1 and the set time period is a second time period.

In some implementations, keeping the main transceiver in the on state for the set time period after the user device sends or receives the set message, includes:
after the user device sends the set message in two-step random access, keeping the main transceiver in the on state for the set time period, where the set message is msgA and the set time period is a third time period.

In some implementations, keeping the main transceiver in the on state for the set time period after the user device sends or receives the set message, includes:
after the user device sends the set message in four-step random access, keeping the main transceiver in the on state for the set time period, where the set message is msg3 and the set time period is the fourth time period.

In some implementations, keeping the main transceiver in the on state for the set time period after the user device sends or receives the set message, includes:
after receiving the set message in a random access triggered by a received paging message, keeping the main transceiver in the on state for the set time period, where the set message is msg4 or msgB, and the set time period is a fifth time period.

In some implementations, keeping the main transceiver in the on state for the set time period after the user device sends or receives the set message, includes:
after receiving the set message in a random access which is triggered by an uplink in an asynchronous state when receiving downlink information, keeping the main transceiver in the on state for the set time period, where the set message is msg4 or msgB, and the set time period is a sixth time period.

In some implementations, keeping the main transceiver in the on state for the set time period after the user device sends or receives the set message, includes:
after sending the set message, keeping the main transceiver in the on state for the set time period, where the set message is a Hybrid Automatic Repeat Request acknowledgment (HARQ-ACK) for Physical Downlink Shared Channel (PDSCH) or Downlink Control Information (DCI), the HARQ-ACK indicates negative acknowledgment (NACK), and the set time period is a seventh time period.

In some implementations, keeping the main transceiver in the on state for the set time period after the user device sends or receives the set message, includes:
after sending the set message, keeping the main transceiver in the on state for the set time period, where the set message is a scheduling request (SR), and the set time period is an eighth time period.

In some implementations, keeping the main transceiver in the on state for the set time period after the user device sends or receives the set message, includes:
after sending the set message and indicating uplink data to be transmitted, keeping the main transceiver in the on state for the set time period, where the set message is a buffer status report (BSR), the set time period is a ninth time period, and the buffer status report BSR includes a Medium Access Contril (MAC) layer BSR transmitted on a Physical Uplink Shared Control Channel (PUSCH) or a physical layer BSR transmitted on a Physical Uplink Control Channel (PUCCH).

In some implementations, the set time period does not include a time slot or symbol that is semi-statically configured as uplink.

In some implementations, the set time period includes at least one of the following:
time slots or symbols that are semi-statically configured as downlink; or
time slots or symbols that are semi-statically configured as downlink and symbols that are indicated as downlink by slot form indicator (SFI).

In some implementations, keeping the main transceiver in the on state for the set time period after the user device sends or receives the set message, includes: after receiving the set message, keeping the main transceiver in the on state for the set time period, where the set message is a set DCI, and the set time period is a tenth time period.

In some implementations, the set DCI includes DCI with Cyclic Redundancy Check (CRC) scrambled by using a Cell-Radio Network Temporary Identifier (C-RNTI), a Configured Scheduling RNTI (CS-RNTI), or a Modulation and Coding Scheme (MCS)-C-RNTI.

In some implementations, the set DCI does not include DCI with CRC scrambled by using Paging RNTI (P-RNTI), System Information RNTI (SI-RNTI), or Random Access RNTI (RA-RNTI).

In some implementations, keeping the main transceiver in the on state for the set time period after the user device sends or receives the set message, includes:
after receiving the set message, keeping the main transceiver in the on state for the set time period, where the set message is a PDSCH, and the set time period is an eleventh time period.

In some implementations, the PDSCH includes a PDSCH scheduled by DCI with CRC scrambled by using C-RNTI, CS-RNTI, or MCS-C-RNTI.

In some implementations, the PDSCH does not include a PDSCH without DCI scheduling, and does not include a PDSCH scheduled by DCI with CRC scrambled by using SI-RNTI.

In some implementations, the set time period is configured by a network device or determined by a protocol.

In some implementations, the start time of the set time period is the end position of the symbol corresponding to the user device sending or receiving the set message, or the end position of the time slot corresponding to sending of the set message.

In a second aspect, a communication device is provided. The communication device is configured to perform the downlink channel monitoring method according to the first aspect. The user device may implement each function in the above-mentioned method in the form of hardware structure, software module, or hardware structure plus software module.

When the communication device shown in the first aspect is implemented in the form of software module, the communication device may include a transceiving module and a processing module.

The transceiving module is configured to send or receive a set message.

The processing module is configured to keep the main transceiver in an on state for a set time period after sending or receiving the set message, where the on state of the main transceiver corresponds to monitoring of a downlink channel.

In a third aspect, a communication device is provided, including a processor and a memory. The memory is configured to store a computer program. The processor is configured to execute the computer program to perform the downlink channel monitoring method according to the first aspect.

In a fourth aspect, a computer-readable storage medium is provided, having instructions (computer programs, or programs) stored therein. When the instructions are executed by a processor, the processor is caused to perform the downlink channel monitoring method according to the first aspect.

### BRIEF DESCRIPTION OF THE DRAWINGS

The drawings described herein are used to provide further understanding of the embodiments of the present disclosure and constitute a part of the present application. The schematic implementations of the embodiments of the present disclosure and their descriptions are used to explain the embodiments of the present disclosure, and do not constitute improper limitations on the embodiments of the present disclosure.

The drawings are incorporated herein into the specification and constitute a part of the specification, showing implementations that conform to the embodiments of the present disclosure, and are used together with the specification to explain the principles of the embodiments of the present disclosure.

FIG. 1 is a schematic diagram of a wireless communication system architecture provided by an embodiment of the present disclosure;

FIG. 2 is a flow chart of a downlink channel monitoring method according to an example embodiment;

FIG. 3 is a flow chart of a downlink channel monitoring method according to an example embodiment;

FIG. 4a is a flow chart of a downlink channel monitoring method according to an example embodiment;

FIG. 4b is a flow chart of a downlink channel monitoring method according to an example embodiment;

FIG. 4c is a flow chart of a downlink channel monitoring method according to an example embodiment;

FIG. 5 is a flow chart of a downlink channel monitoring method according to an example embodiment;

FIG. 6 is a structural diagram of a downlink channel monitoring device according to an example embodiment; and

FIG. 7 is a structural diagram of a downlink channel monitoring device according to an example embodiment.

### DETAILED DESCRIPTION OF THE EMBODIMENTS

Example embodiments of the present disclosure are now described in further details in conjunction with the drawings and the specific implementations.

The example embodiments will be described in detail here, and examples thereof are shown in the drawings. When the following description refers to the drawings, unless otherwise indicated, the same numbers in different drawings represent the same or similar elements. The implementations described in the following example embodiments do not represent all the implementations consistent with the embodiments of the present disclosure. Instead, they are only examples of devices and methods consistent with some aspects of the present disclosure as detailed in the attached claims.

The terms used in the embodiments of the present disclosure are only for the purpose of describing specific implementations, and are not intended to limit the embodiments of the present disclosure. The singular forms “one” and “the” used in the embodiments of the present disclosure and the attached claims are also intended to include plural forms as well, unless the context clearly indicates otherwise. It should also be understood that the term “and/or” used herein refers to and includes any or all possible combinations of one or more associated items as listed.

It should be understood that although the terms first, second, third, etc. may be used in the embodiments of the present disclosure to describe various information, these information should not be limited only to these terms. These terms are merely used to distinguish the same type of information from each other. For example, without departing from the scope of the embodiments of the present disclosure, the first information may also be referred to as the second information, and similarly, the second information may also be referred to as the first information. Depending on the context, the words “if” used herein may be interpreted as “while” or “when” or “in response to determining”.

The embodiments of the present disclosure are described in detail below, and examples of the embodiments are shown in the accompanying drawings, where the same or similar reference numerals represent the same or similar elements. The embodiments described below with reference to the accompanying drawings are examples and are intended for use in explaining the present disclosure, and cannot be understood as limiting the present disclosure.

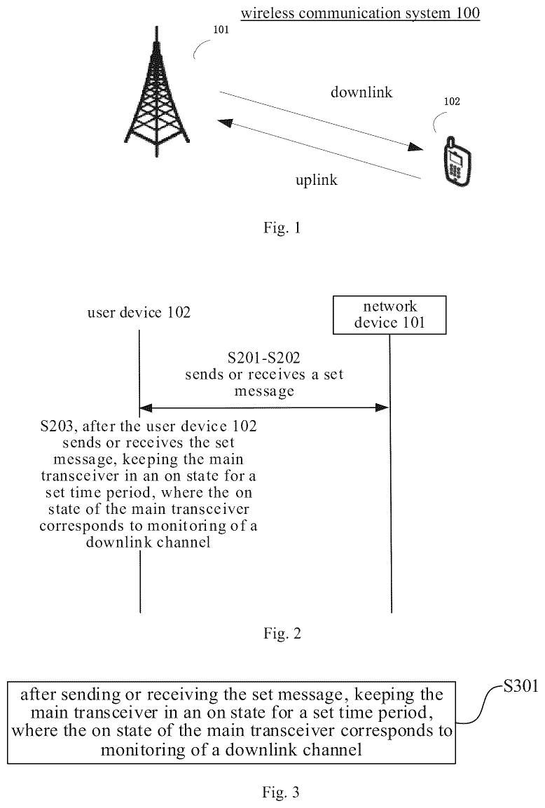

As shown in FIG. 1, a downlink channel monitoring method provided in an embodiment of the present disclosure may be applied to a wireless communication system 100, which may include, but is not limited to, a network device 101 and a user device 102. The user device 102 is configured to support carrier aggregation, and the user device 102 may be connected to multiple carrier units of the network device 101, including a main carrier unit and one or more auxiliary carrier units.

It should be understood that the above wireless communication system 100 may be applicable to both low-frequency scenarios and high-frequency scenarios. The application scenarios of the wireless communication system 100 include, but are not limited to, long term evolution (LTE) system, LTE frequency division duplex (FDD) system, LTE time division duplex (TDD) system, worldwide interoperability for micro wave access (WiMAX) communication system, cloud radio access network (CRAN) system, future 5th generation (5G) system, new radio (NR) communication system, or future evolved public land mobile network (PLMN) system, etc.

The user device 102 shown above may be user equipment (UE), terminal, access terminal, terminal unit, terminal station, mobile station (MS), remote station, remote terminal, mobile terminal, wireless communication device, terminal agent, or user apparatus, etc. The user device 102 may have a wireless transceiving function, and may communicate with one or more network devices 101 of one or more communication systems (such as in a wireless communication), and receive network services provided by the network device 101. The network device 101 here includes, but is not limited to, the base station shown in the figure.

The user device 102 may be a cellular phone, a cordless phone, a session initiation protocol (SIP) phone, a wireless local loop (WLL) station, a personal digital assistant (PDA) device, a handheld device with wireless communication function, a computing device, or other processing device connected to a wireless modem, a vehicle-mounted device, a wearable device, a user device in a future 5G network, or a user device in a future evolved PLMN network, etc.

The network device 101 may be an access network device (or access network site). The access network device refers to a device that provides network access function, such as a radio access network (RAN) base station, etc. The network device may specifically include a base station (BS) device, or include a base station device and a wireless resource management device for controlling the base station device, etc. The network device may also include a relay station (relay device), an access point, a base station in a future 5G network, a base station in a future evolved PLMN network, or an NR base station, etc. The network device may be a wearable device or an in-vehicle device. The network device may also be a communication chip with a communication module.

For example, the network device 101 includes, but is not limited to, a next-generation base station (gnodeB, gNB) in 5G, an evolved node B (eNB) in an LTE system, a radio network controller (RNC), a node B (NB) in a WCDMA system, a wireless controller under a CRAN system, a base station controller (BSC), a base transceiver station (BTS) in a GSM system or a CDMA system, a home base station (for example, home evolved nodeB, or home node B, HNB), a baseband unit (BBU), a transmitting and receiving point (TRP), a transmitting point (TP), or a mobile switch center, etc.

An embodiment of the present disclosure provides a downlink channel monitoring method. FIG. 2 is a flow chart of a downlink channel monitoring method according to an exemplary embodiment. As shown in FIG. 2, the method includes the following steps.

Step S201, the network device 101 receives or sends a set message.

Step S202, the user device 102 sends or receives a set message.

Step S203, after the user device 102 sends or receives the set message, the main transceiver is kept in an on state for a set time period, where the on state of the main transceiver corresponds to monitoring of a downlink channel.

In the embodiment of the present disclosure, after the user device sends or receives the set message, the main transceiver is kept in the on state for the set time period for downlink channel monitoring. Thus, the main transceiver can be turned on without the need for a wake-up signal to trigger, thereby reducing the dependence on the wake-up signal and improving the active processing capability of the user device.

An embodiment of the present disclosure provides a downlink channel monitoring method, which is performed by the user device 102. The method may be performed independently or in combination with any other embodiment among the embodiments of the present disclosure. FIG. 3 is a flow chart of a downlink channel monitoring method according to an example embodiment. As shown in FIG. 3, the method includes the following step.

Step S301, after sending or receiving the set message, the main transceiver is kept in an on state for a set time period, where the on state of the main transceiver corresponds to monitoring of a downlink channel.

In some implementations, the set time period is configured by a network device or determined by a protocol.

In some implementations, the set time period is the number of Orthogonal Frequency Division Multiplexing (OFDM) symbols, the number of sub-time slots, or the number of time slots.

In some implementations, the start time of the set time period is the end position of the symbol corresponding to the user device 102 sending or receiving the set message, or the end position of the time slot corresponding to sending of the set message.

In the embodiment of the present disclosure, after the user device sends or receives the set message, the main transceiver is kept in the on state for the set time period for downlink channel monitoring. Thus, the main transceiver can be turned on without the need for a wake-up signal to trigger, thereby reducing the dependence on the wake-up signal and improving the active processing capability of the user device.

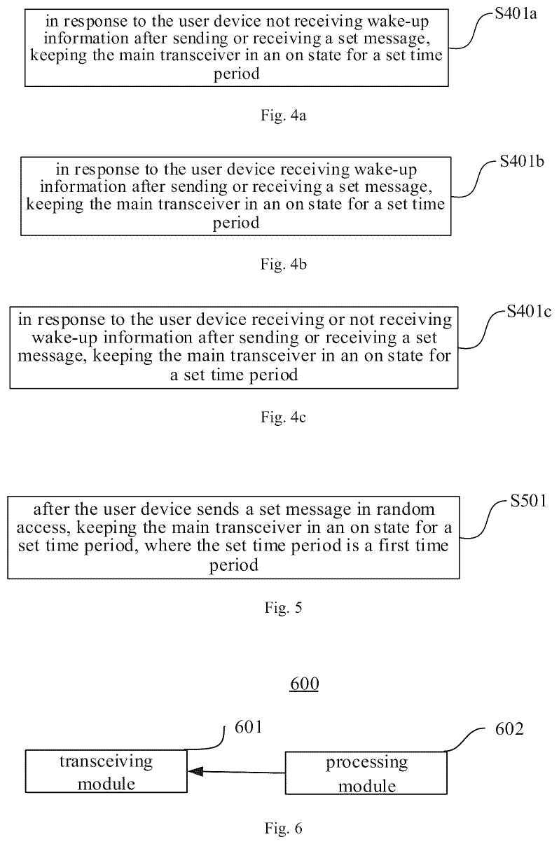

An embodiment of the present disclosure provides a downlink channel monitoring method, which is performed by the user device 102. The method may be performed independently or in combination with any other embodiment among the embodiments of the present disclosure. FIG. 4a is a flow chart of a downlink channel monitoring method according to an example embodiment. As shown in FIG. 4a, the method includes the following step.

Step S401a, in response to the user device not receiving wake-up information after sending or receiving a set message, the main transceiver is kept in an on state for a set time period.

In some implementations, the set time period is configured by a network device or determined by a protocol.

In some implementations, the set time period is the number of OFDM symbols, the number of sub-time slots, or the number of time slots.

In some implementations, the start time of the set time period is the end position of the symbol corresponding to the user device 102 sending or receiving the set message, or the end position of the time slot corresponding to sending of the set message.

In the embodiment of the present disclosure, after the user device sends or receives the set message, even if the wake-up information is not received, the main transceiver is still kept in the on state for the set time period for downlink channel monitoring, thereby reducing the dependence on the wake-up signal and improving the active processing capability of the user device.

An embodiment of the present disclosure provides a downlink channel monitoring method, which is performed by the user device 102. The method may be performed independently or in combination with any other embodiment among the embodiments of the present disclosure. FIG. 4b is a flow chart of a downlink channel monitoring method according to an example embodiment. As shown in FIG. 4b, the method includes the following step.

Step S401b, in response to the user device receiving wake-up information after sending or receiving a set message, the main transceiver is kept in an on state for a set time period.

In some implementations, the set time period is configured by a network device or determined by a protocol.

In some implementations, the set time period is the number of OFDM symbols, the number of sub-time slots, or the number of time slots.

In some implementations, the start time of the set time period is the end position of the symbol corresponding to the user device 102 sending or receiving the set message, or the end position of the time slot corresponding to sending of the set message.

In some implementations, the priority for sending or receiving the set message is higher than that for receiving the wake-up information.

In the embodiment of the present disclosure, after the user device sends or receives the set message, the wake-up information is received, and sending or receiving of the set message causes the main transceiver to be kept in the on state for the set time period for downlink channel monitoring.

An embodiment of the present disclosure provides a downlink channel monitoring method, which is performed by the user device 102. The method may be performed independently or in combination with any other embodiment among the embodiments of the present disclosure. FIG. 4c is a flow chart of a downlink channel monitoring method according to an example embodiment. As shown in FIG. 4c, the method includes the following step.

Step S401c, in response to the user device receiving or not receiving wake-up information after sending or receiving a set message, the main transceiver is kept in an on state for a set time period.

In some implementations, the set time period is configured by a network device or determined by a protocol.

In some implementations, the set time period is the number of OFDM symbols, the number of sub-time slots, or the number of time slots.

In some implementations, the start time of the set time period is the end position of the symbol corresponding to the user device 102 sending or receiving the set message, or the end position of the time slot corresponding to sending of the set message.

In some implementations, the priority for sending or receiving the set message is higher than that for receiving the wake-up information.

In the embodiment of the present disclosure, after the user device sends or receives the set message, regardless of whether the wake-up information is received, the main transceiver is kept in the on state for the set time period for downlink channel monitoring, thereby reducing the dependence on the wake-up signal and improving the active processing capability of the user device.

An embodiment of the present disclosure provides a downlink channel monitoring method, which is performed by the user device 102. The method may be performed independently or in combination with any other embodiment among the embodiments of the present disclosure. The method includes the following step.

After the user device sends or receives a set message, the main transceiver is kept in an on state for a set time period, where the on state of the main transceiver corresponds to monitoring of a downlink channel, and the set time period corresponds to the set message.

In some implementations, the set time period is configured by a network device or determined by a protocol.

In some implementations, the set time period is the number of OFDM symbols, the number of sub-time slots, or the number of time slots.

In some implementations, when the set message becomes different, the set time period also becomes different accordingly. Thus, different set time periods are configured for different set messages, so that the time period for which the main transceiver keeps in the on state can be reasonable under different application scenarios.

In some implementations, the start time of the set time period is the end position of the symbol corresponding to the user device sending or receiving the set message, or the end position of the time slot corresponding to sending of the set message.

In the embodiment of the present disclosure, after the user device sends or receives the set message, the main transceiver is kept in the on state for the set time period corresponding to the set message, where the on state of the main transceiver corresponds to monitoring of a downlink channel. In addition, different set time periods are configured for different set messages, so that the time period for which the main transceiver keeps in the on state can be reasonable under different application scenarios.

An embodiment of the present disclosure provides a downlink channel monitoring method, which is performed by the user device 102. The method may be performed independently or in combination with any other embodiment among the embodiments of the present disclosure. FIG. 5 is a flow chart of a downlink channel monitoring method according to an example embodiment. As shown in FIG. 5, the method includes the following step.

Step S501, after the user device sends a set message in random access, the main transceiver is kept in an on state for a set time period, where the set time period is a first time period.

In some implementations, in step S501, after the user device sends the set message in random access, the main transceiver is kept in the on state for the first time period.

In some implementations, the first time period is configured by a network device or determined by a protocol.

In some implementations, the first time period is the number of OFDM symbols, the number of sub-time slots, or the number of time slots.

In some implementations, the start time of the first time period is the end position of the symbol corresponding to the user device sending or receiving the set message, or the end position of the time slot corresponding to sending of the set message.

In the embodiment of the present disclosure, after the user device sends the set message in random access, the main transceiver is kept in the on state for the first time period, where the on state of the main transceiver corresponds to monitoring of a downlink channel. Thus, there is no need to rely on the wake-up signal during the random access process, thereby improving the active processing capability of the user device.

An embodiment of the present disclosure provides a downlink channel monitoring method, which is performed by the user device 102. The method may be performed independently or in combination with any other embodiment among the embodiments of the present disclosure. The method includes the following step.

In an embodiment, after the user device sends a set message in four-step random access, the main transceiver is kept in an on state for a set time period, where the set message is msg1 and the set time period is a second time period.

In an embodiment, after the user device sends msg1 in four-step random access, the main transceiver is kept in the on state for the second time period.

In some implementations, the second time period is configured by a network device or determined by a protocol.

In some implementations, the second time period is the number of OFDM symbols, the number of sub-time slots, or the number of time slots.

In some implementations, the start time of the second time period is the end position of the symbol corresponding to the user device sending or receiving the set message, or the end position of the time slot corresponding to sending of the set message.

In the embodiment of the present disclosure, after the user device sends msg1 in four-step random access, the main transceiver is kept in the on state for the second time period, where the on state of the main transceiver corresponds to monitoring of a downlink channel. Thus, there is no need to rely on the wake-up signal during the random access process, which improves the active processing capability of the user device.

An embodiment of the present disclosure provides a downlink channel monitoring method, which is performed by the user device 102. The method may be performed independently or in combination with any other embodiment among the embodiments of the present disclosure. The method includes the following step.

After the user device sends a set message in two-step random access, the main transceiver is kept in an on state for a set time period, where the set message is msgA and the set time period is a third time period.

In an embodiment, after the user device sends msgA in two-step random access, the main transceiver is kept in the on state for the third time period.

In some implementations, the third time period is configured by a network device or determined by a protocol.

In some implementations, the third time period is the number of OFDM symbols, the number of sub-time slots, or the number of time slots.

In some implementations, the start time of the third time period is the end position of the symbol corresponding to the user device sending or receiving the set message, or the end position of the time slot corresponding to sending of the set message.

In the embodiment of the present disclosure, after the user device sends msgA in two-step random access, the main transceiver is kept in the on state for the third time period, where the on state of the main transceiver corresponds to monitoring of a downlink channel. Thus, there is no need to rely on the wake-up signal during the random access process, which improves the active processing capability of the user device.

An embodiment of the present disclosure provides a downlink channel monitoring method, which is performed by a user device 102. The method may be performed independently or in combination with any other embodiment among the embodiments of the present disclosure. The method includes the following step.

After the user device sends a set message in four-step random access, the main transceiver is kept in an on state for a set time period, where the set message is msg3 and the set time period is a fourth time period.

In an embodiment, after the user device sends msg3 in four-step random access, the main transceiver is kept in the on state for the fourth time period.

In some implementations, the fourth time period is configured by a network device or determined by a protocol.

In some implementations, the fourth time period is the number of OFDM symbols, the number of sub-time slots, or the number of time slots.

In some implementations, the start time of the fourth time period is the end position of the symbol corresponding to the user device sending or receiving the set message, or the end position of the time slot corresponding to sending of the set message.

In the embodiment of the present disclosure, after the user device sends msg3 in four-step random access, the main transceiver is kept in the on state for the fourth time period, where the on state of the main transceiver corresponds to monitoring of a downlink channel. Thus, there is no need to rely on the wake-up signal during the random access process, which improves the active processing capability of the user device.

An embodiment of the present disclosure provides a downlink channel monitoring method, which is performed by the user device 102. The method may be performed independently or in combination with any other embodiment among the embodiments of the present disclosure. The method includes the following step.

After the user device receives a set message in a random access triggered by a received paging message, the main transceiver is kept in an on state for a set time period, where the set message is msg4 or msgB, and the set time period is a fifth time period.

In an embodiment, after the user device receives msg4 or msgB in the random access triggered by the received paging message, the main transceiver is kept in the on state for the fifth time period.

In some implementations, the fifth time period is configured by a network device or determined by a protocol.

In some implementations, the fifth time period is the number of OFDM symbols, the number of sub-time slots, or the number of time slots.

In some implementations, the start time of the fifth time period is the end position of the symbol corresponding to the user device sending or receiving the set message, or the end position of the time slot corresponding to sending of the set message.

In the embodiment of the present disclosure, after the user device receives msg4 or msgB in the random access triggered by the received paging message, the main transceiver is kept in the on state for the fifth time period, where the on state of the main transceiver corresponds to monitoring of a downlink channel. Thus, there is no need to rely on the wake-up signal during the random access process, which improves the active processing capability of the user device.

An embodiment of the present disclosure provides a downlink channel monitoring method, which is performed by the user device 102. The method may be performed independently or in combination with any other embodiment among the embodiments of the present disclosure. The method includes the following step.

After the user device receives a set message in a random access triggered by an uplink in an asynchronous state when receiving downlink information, the main transceiver is kept in an on state for a set time period, where the set message is msg4 or msgB, and the set time period is a sixth time period.

In an embodiment, after the user device receives msg4 or msgB in the random access triggered by the uplink in an asynchronous state when receiving downlink information, the main transceiver is kept in the on state for the sixth time period.

In some implementations, the sixth time period does not include a time slot or symbol that is semi-statically configured as uplink.

In an example, a timer is set which includes several time slots and corresponds to the sixth time period. When passing through a time slot that is semi-statically configured as uplink, the timer remains unchanged. When passing through other time slots, the timer is reduced by 1.

In an example, a timer is set which includes several symbols and corresponds to the sixth time period. When passing through a symbol that is semi-statically configured as uplink, the timer remains unchanged. When passing through other symbols, the timer is reduced by 1.

In some implementations, the sixth time period only includes time slots or symbols that are semi-statically configured as downlink.

In an example, a timer is set which includes several time slots and corresponds to the sixth time period. When passing through a time slot that is semi-statically configured as downlink, the timer is reduced by 1. When passing through other time slots, the timer remains unchanged.

In an example, a timer is set which includes several symbols and corresponds to the sixth time period. When passing through a symbol that is semi-statically configured as downlink, the timer is reduced by 1. When passing through other symbols, the timer remains unchanged.

In some implementations, the sixth time period only includes time slots or symbols that are semi-statically configured as downlink and symbols that are indicated as downlink by SFI.

In some implementations, the sixth time period is configured by a network device or determined by a protocol.

In some implementations, the sixth time period is the number of OFDM symbols, the number of sub-time slots, or the number of time slots.

In some implementations, the start time of the sixth time period is the end position of the symbol corresponding to the user device sending or receiving the set message, or the end position of the time slot corresponding to sending of the set message.

In the embodiment of the present disclosure, after the user device receives msg4 or msgB in the random access triggered by the received paging message, the main transceiver is kept in the on state for the sixth time period, where the on state of the main transceiver corresponds to monitoring of a downlink channel, thereby not relying on the wake-up signal, and improving the active processing capability of the user device.

An embodiment of the present disclosure provides a downlink channel monitoring method, which is performed by a user device 102. The method may be performed independently or in combination with any other embodiment among the embodiments of the present disclosure. The method includes the following step.

After the user device sends a set message, the main transceiver is kept in an on state for a set time period, where the set message is HARQ-ACK for PDSCH or DCI, the HARQ-ACK indicates NACK, and the set time period is a seventh time period.

In an embodiment, after the user device sends the HARQ-ACK for PDSCH or DCI, the main transceiver is kept in the on state for the seventh time period, where the HARQ-ACK indicates NACK.

In some implementations, the seventh time period does not include a time slot or symbol that is semi-statically configured as uplink.

In an example, a timer is set which includes several time slots and corresponds to the seventh time period. When passing through a time slot that is semi-statically configured as uplink, the timer remains unchanged. When passing through other time slots, the timer is reduced by 1.

In an example, a timer is set which includes several symbols and corresponds to the seventh time period. When passing through a symbol that is semi-statically configured as uplink, the timer remains unchanged. When passing through other symbols, the timer is reduced by 1.

In some implementations, the sixth time period only includes time slots or symbols that are semi-statically configured as downlink.

In an example, a timer is set which includes several time slots and corresponds to the seventh time period. When passing through a time slot that is semi-statically configured as downlink, the timer is reduced by 1. When passing through other time slots, the timer remains unchanged.

In an example, a timer is set which includes several symbols and corresponds to the seventh time period. When passing through a symbol that is semi-statically configured as downlink, the timer is reduced by 1. When passing through other symbols, the timer remains unchanged.

In some implementations, the seventh time period only includes time slots or symbols that are semi-statically configured as downlink and symbols that are indicated as downlink by SFI.

In some implementations, the seventh time period is configured by a network device or determined by a protocol.

In some implementations, the seventh time period is the number of OFDM symbols, the number of sub-time slots, or the number of time slots.

In some implementations, the start time of the seventh time period is the end position of the symbol corresponding to the user device sending or receiving the set message, or the end position of the time slot corresponding to sending of the set message.

In the embodiment of the present disclosure, after the user device sends the HARQ-ACK for PDSCH or DCI (the HARQ-ACK indicates NACK), the main transceiver is kept in the on state for the seventh time period, where the on state of the main transceiver corresponds to monitoring of a downlink channel. Thus, there is no need to rely on the wake-up signal, which improves the active processing capability of the user device.

An embodiment of the present disclosure provides a downlink channel monitoring method, which is performed by the user device 102. The method may be performed independently or in combination with any other embodiment among the embodiments of the present disclosure. The method includes the following step.

After the user device sends a set message, the main transceiver is kept in an on state for a set time period, where the set message is a scheduling request SR, and the set time period is an eighth time period.

In an embodiment, after the user device sends the scheduling request SR, the main transceiver is kept in the on state for the eighth time period.

In some implementations, the eighth time period does not include time slots or symbols that are semi-statically configured as uplink.

In an example, a timer is set which includes several time slots and corresponds to the eighth time period. When passing through a time slot that is semi-statically configured as uplink, the timer remains unchanged. When passing through other time slots, the timer is reduced by 1.

In an example, a timer is set which includes several symbols and corresponds to the eighth time period. When passing through a symbol that is semi-statically configured as uplink, the timer remains unchanged. When passing through other symbols, the timer is reduced by 1.

In some implementations, the eighth time period only includes time slots or symbols that are semi-statically configured as downlink.

In an example, a timer is set which includes several time slots and corresponds to the eighth time period. When passing through a time slot that is semi-statically configured as downlink, the timer is reduced by 1. When passing through other time slots, the timer remains unchanged.

In an example, a timer is set which includes several symbols and corresponds to the eighth time period. When passing through a symbol that is semi-statically configured as downlink, the timer is reduced by 1. When passing through other symbols, the timer remains unchanged.

In some implementations, the eighth time period only includes time slots or symbols that are semi-statically configured as downlink and symbols that are indicated as downlink by the SFI.

In some implementations, the eighth time period is configured by a network device or determined by a protocol.

In some implementations, the eighth time period is the number of OFDM symbols, the number of sub-time slots, or the number of time slots.

In some implementations, the start time of the eighth time period is the end position of the symbol corresponding to the user device sending or receiving the set message, or the end position of the time slot corresponding to sending of the set message.

In the embodiment of the present disclosure, after the user device sends the scheduling request SR, the main transceiver is kept in the on state for the eighth time period, where the on state of the main transceiver corresponds to monitoring of a downlink channel, thereby not relying on the wake-up signal, and improving the active processing capability of the user device.

An embodiment of the present disclosure provides a downlink channel monitoring method, which is performed by the user device 102. The method may be performed independently or in combination with any other embodiment among the embodiments of the present disclosure. The method includes the following step.

After the user device sends a set message and indicates uplink data to be transmitted, the main transceiver is kept in an on state for a set time period, where the buffer status report BSR includes a MAC layer BSR transmitted on PUSCH or a physical layer BSR transmitted on PUCCH, and the set time period is a ninth time period.

In an embodiment, after the user device sends the buffer status report BSR and indicates the uplink data to be transmitted, the main transceiver is kept in the on state for the ninth time period, where the buffer status report BSR includes a MAC layer BSR transmitted on PUSCH or a physical layer BSR transmitted on PUCCH.

In some implementations, the ninth time period does not include a time slot or symbol that is semi-statically configured as uplink.

In an example, a timer is set which includes several time slots and corresponds to the ninth time period. When passing through a time slot that is semi-statically configured as uplink, the timer remains unchanged. When passing through other time slots, the timer is reduced by 1.

In an example, a timer is set which includes several symbols and corresponds to the ninth time period. When passing through a symbol that is semi-statically configured as uplink, the timer remains unchanged. When passing through other symbols, the timer is reduced by 1.

In some implementations, the set time period includes at least one of the following:
time slots or symbols that are semi-statically configured as downlink; or
time slots or symbols that are semi-statically configured as downlink, and symbols that are indicated as downlink by SFI.

In some implementations, the ninth time period only includes time slots or symbols that are semi-statically configured as downlink.

In an example, a timer is set which includes several time slots and corresponds to the ninth time period. When passing through a time slot that is semi-statically configured as downlink, the timer is reduced by 1. When passing through other time slots, the timer remains unchanged.

In an example, a timer is set which includes several symbols and corresponds to the ninth time period. When passing through a symbol that is semi-statically configured as downlink, the timer is reduced by 1. When passing through other symbols, the timer remains unchanged.

In some implementations, the ninth time period only includes time slots or symbols that are semi-statically configured as downlink, and symbols that are indicated as downlink by SFI.

In some implementations, the ninth time period is configured by a network device or determined by a protocol.

In some implementations, the ninth time period is the number of OFDM symbols, the number of sub-time slots, or the number of time slots.

In some implementations, the start time of the ninth time period is the end position of the symbol corresponding to the user device sending or receiving the set message, or the end position of the time slot corresponding to sending of the set message.

In the embodiment of the present disclosure, after the user device sends the set message and indicates the uplink data to be transmitted, the main transceiver is kept in the on state for the ninth time period, where the on state of the main transceiver corresponds to monitoring of a downlink channel. Thus, there is no need to rely on the wake-up signal, which improves the active processing capability of the user device.

An embodiment of the present disclosure provides a downlink channel monitoring method, which is performed by the user device 102. The method may be performed independently or in combination with any other embodiment among the embodiments of the present disclosure. The method includes the following step.

In response to the user device receiving a set message, the main transceiver is kept in an on state for a set time period, where the set message is a set DCI, and the set time period is a tenth time period.

In an embodiment, in response to the user device receiving the set DCI, the main transceiver is kept in the on state for the tenth time period.

In some implementations, the set DCI includes DCI with CRC scrambled by using C-RNTI, CS-RNTI, or MCS-C-RNTI.

In some implementations, the set DCI does not include DCI with CRC scrambled by using P-RNTI, SI-RNTI, or RA-RNTI.

In some implementations, the set DCI includes DCI with CRC scrambled by using C-RNTI, CS-RNTI, or MCS-C-RNTI, and does not include DCI with CRC scrambled by using P-RNTI, SI-RNTI, or RA-RNTI.

In some implementations, the tenth time period is configured by a network device or determined by a protocol.

In some implementations, the tenth time period is the number of OFDM symbols, the number of sub-time slots, or the number of time slots.

In some implementations, the start time of the tenth time period is the end position of the symbol corresponding to the user device sending or receiving the set message, or the end position of the time slot corresponding to sending of the set message.

In the embodiment of the present disclosure, after the user device sends or receives the set DCI message, the main transceiver is kept in the on state for the tenth time period, where the on state of the main transceiver corresponds to monitoring of a downlink channel. Thus, there is no need to rely on the wake-up signal, which improves the active processing capability of the user device.

An embodiment of the present disclosure provides a downlink channel monitoring method, which is performed by the user device 102. The method may be performed independently or in combination with any other embodiment among the embodiments of the present disclosure. The method includes the following step.

After the user device receives a set message, the main transceiver is kept in an on state for a set time period, where the set message is a PDSCH, and the set time period is an eleventh time period.

In an embodiment, after the user device receives the PDSCH, the main transceiver is kept in the on state for the eleventh time period.

In some implementations, the PDSCH includes a PDSCH scheduled by DCI with CRC scrambled by using a C-RNTI, CS-RNTI, or MCS-C-RNTI.

In some implementations, the PDSCH does not include a PDSCH without DCI scheduling, and does not include a PDSCH scheduled by DCI with CRC scrambled by using SI-RNTI.

In some implementations, the PDSCH includes a PDSCH scheduled by DCI with CRC scrambled by using C-RNTI, CS-RNTI, or MCS-C-RNTI, but does not include a PDSCH without DCI scheduling, and does not include a PDSCH scheduled by DCI with CRC scrambled by using SI-RNTI.

In some implementations, the eleventh time period is configured by a network device or determined by a protocol.

In some implementations, the eleventh time period is the number of OFDM symbols, the number of sub-slots, or the number of slots.

In some implementations, the start time of the eleventh time period is the end position of the symbol corresponding to the user device sending or receiving the set message, or the end position of the time slot corresponding to sending of the set message.

In the embodiment of the present disclosure, after the user device sends or receives the PDSCH, the main transceiver is kept in the on state for the eleventh time period, where the on state of the main transceiver corresponds to monitoring of a downlink channel, thereby eliminating the need to rely on a wake-up signal, and improving the active processing capability of the user device.

Based on the same concept as the above method embodiments, an embodiment of the present disclosure further provides a communication device. The communication device may have functions of the user device 102 in the above method embodiments, and is configured to implement the steps performed by the user device 102 provided in the above embodiments. The functions may be implemented by hardware, or by software or hardware executing the respective software. The hardware or software includes one or more modules corresponding to the above functions.

In animplementation, the communication device 600 shown in FIG. 6 may be used as the user device 102 involved in the above method embodiments, and implement the steps performed by the user device 102 in the above method embodiments.

The communication device 600 includes a transceiving module 601 and a processing module 602.

The transceiving module 601 is configured to send or receive a set message.

The processing module 602 is configured to keep the main transceiver in an on state for a set time period after sending or receiving the set message, where the on state of the main transceiver corresponds to monitoring of a downlink channel.

In some implementations, the processing module 602 is configured to: keep the main transceiver in the on state for the set time period, in response to the transceiving module 601 receiving or not receiving wake-up information after sending or receiving the set message.

In some implementations, the set time period corresponds to the set message.

In some implementations, the processing module 602 is configured to: keep the main transceiver in the on state for the set time period, in response to the transceiving module 601 sending the set message in random access, where the set time period is a first time period.

In some implementations, the processing module 602 is configured to: keep the main transceiver in the on state for the set time period, after the transceiving module 601 sends the set message in four-step random access, where the set message is msg1 and the set time period is a second time period.

In some implementations, the processing module 602 is configured to: keep the main transceiver in the on state for the set time period, after the transceiving module 601 sends the set message in two-step random access, where the set message is msgA and the set time period is a third time period.

In some implementations, the processing module 602 is configured to: keep the main transceiver in the on state for the set time period, after the transceiving module 601 sends the set message in four-step random access, where the set message is msg3 and the set time period is a fourth time period.

In some implementations, the processing module 602 is configured to: keep the main transceiver in the on state for the set time period, in response to receiving the set message in a random access triggered by a received paging message, where the set message is msg4 or msgB, and the set time period is a fifth time period.

In some implementations, the processing module 602 is configured to: keep the main transceiver in the on state for the set time period, after receiving the set message in a random access triggered by an uplink in an asynchronous state when receiving downlink information, where the set message is msg4 or msgB, and the set time period is a sixth time period.

In some implementations, the processing module 602 is configured to: keep the main transceiver in the on state for the set time period after sending the set message, where the set message is a HARQ-ACK for PDSCH or DCI, the HARQ-ACK indicates NACK, and the set time period is a seventh time period.

In some implementations, the processing module 602 is configured to: keep the main transceiver in the on state for the set time period after sending the set message, where the set message is a scheduling request SR, and the set time period is an eighth time period.

In some implementations, the processing module 602 is configured to: keep the main transceiver in the on state for the set time period, in response to sending the set message and indicating uplink data to be transmitted, where the set message is a buffer status report BSR, the set time period is a ninth time period, and the buffer status report BSR includes a MAC layer BSR transmitted on PUSCH or a physical layer BSR transmitted on PUCCH.

In some implementations, the set time period does not include a time slot or symbol that is semi-statically configured as uplink.

In some implementations, the set time period only includes time slots or symbols that are semi-statically configured as downlink.

In some implementations, the set time period only includes time slots or symbols that are semi-statically configured as downlink and symbols that are indicated as downlink by SFI.

In some implementations, the processing module 602 is configured to: keep the main transceiver in the on state for the set time period in response to receiving the set message, where the set message is a set DCI, and the set time period is a tenth time period.

In some implementations, the set DCI includes DCI with CRC scrambled by using C-

RNTI, CS-RNTI, or MCS-C-RNTI.

In some implementations, the set DCI does not include DCI with CRC scrambled by using P-RNTI, SI-RNTI, or RA-RNTI.

In some implementations, the set DCI includes DCI with CRC scrambled by using C-RNTI, CS-RNTI, or MCS-C-RNTI, and does not include DCI with CRC scrambled by using P-RNTI, SI-RNTI, or RA-RNTI.

In some implementations, the processing module 602 is configured to: keep the main transceiver in the on state for the set time period in response to receiving the set message, where the set message is a PDSCH, and the set time period is an eleventh time period.

In some implementations, the PDSCH includes a PDSCH scheduled by DCI with CRC scrambled by using a C-RNTI, CS-RNTI, or MCS-C-RNTI.

In some implementations, the PDSCH does not include a PDSCH without DCI scheduling, and does not include a PDSCH scheduled by DCI with CRC scrambled by using a SI-RNTI.

In some implementations, the PDSCH includes a PDSCH scheduled by DCI with CRC scrambled by using a C-RNTI, CS-RNTI, or MCS-C-RNTI, but does not include a PDSCH without DCI scheduling, and does not include a PDSCH scheduled by DCI with CRC scrambled by using SI-RNTI.

In some implementations, the set time period is configured by a network device or determined by a protocol.

In some implementations, the start time of the set time period is the end position of the symbol corresponding to the user device sending or receiving the set message, or the end position of the time slot corresponding to sending of the set message.

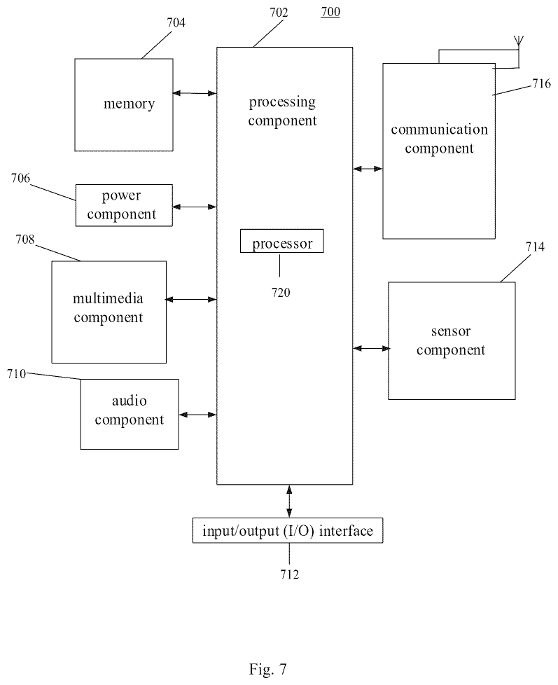

When the communication device is a user device, the structure thereof may be as shown in FIG. 7. FIG. 7 is a block diagram of a downlink channel monitoring device according to an example embodiment. For example, the device 700 may be a mobile phone, a computer, a digital broadcast terminal, a message transceiving device, a game console, a tablet device, a medical device, a fitness device, a personal digital assistant, etc.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 generally controls the overall operation of the device 700, such as operations associated with display, phone calls, data communications, camera operations, and recording operations. The processing component 702 may include one or more processors 720 for executing instructions to complete all or part of the steps in the above methods. In addition, the processing component 702 may include one or more modules to facilitate interactions between the processing component 702 and other components. For example, the processing component 702 may include a multimedia module to facilitate interactions between the multimedia component 708 and the processing component 702.

The memory 704 is configured to store various types of data to support operations on the device 700. Examples of such data include: instructions for any application or method operating on the device 700, contact data, phone book data, messages, pictures, videos, etc. The memory 704 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power component 706 provides power for various components of the device 700. The power component 706 may include a power management system, one or more power supplies, and other components associated with generating, managing, and distributing power for the device 700.

The multimedia component 708 includes a screen that provides an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touch, slide, and gestures on the touch panel. The touch sensor may not only sense the boundary of the touch or slide operation, but also detect the duration and pressure associated with the touch or slide operation. In some embodiments, the multimedia component 708 includes a front camera and/or a rear camera. When the device 700 is in an operation mode, such as a shooting mode or a video mode, the front camera and/or the rear camera may receive external multimedia data. Each of the front camera and the rear camera may be a fixed optical lens system or have a focal length and optical zooming capabilities.

The audio component 710 is configured to output and/or input audio signals. For example, the audio component 710 includes a microphone (MIC). When the device 700 is in an operation mode, such as a call mode, a recording mode, and a voice recognition mode, the microphone is configured to receive external audio signals. The received audio signal may be further stored in the memory 704 or sent via the communication component 716. In some embodiments, the audio component 710 further includes a speaker for outputting audio signals.

The I/O interface 712 provides an interface between the processing component 702 and a peripheral interface module, which may be a keyboard, a click wheel, a button, etc. The button may include, but is not limited to, a home button, a volume button, a start button, and a lock button.

The sensor component 714 includes one or more sensors for providing various aspects of status assessment for the device 700. For example, the sensor component 714 may detect the on/off state of the device 700, the relative positioning among components, such as display and keypad of the device 700. The sensor component 714 may also detect the position change of the device 700 or a component of the device 700, the presence or absence of user contact with the device 700, the orientation or acceleration/deceleration of the device 700, and the temperature change of the device 700. The sensor component 714 may include a proximity sensor, which is configured to detect the presence of a nearby object without any physical contact. The sensor component 714 may also include an optical sensor, such as a CMOS or CCD image sensor, for use in imaging applications. In some embodiments, the sensor component 714 may also include an acceleration sensor, a gyroscope sensor, a magnetic sensor, a pressure sensor, or a temperature sensor.

The communication component 716 is configured to facilitate wired or wireless communications between the device 700 and other devices. The device 700 may access a wireless network based on a communication standard, such as WiFi, 4G or 5G, or a combination thereof. In an example embodiment, the communication component 716 receives a broadcast signal or broadcast-related information from an external broadcast management system via a broadcast channel. In an example embodiment, the communication component 716 also includes a near field communication (NFC) module to facilitate short-range communications. For example, the NFC module may be implemented based on radio frequency identification (RFID) technology, infrared data association (IrDA) technology, ultra-wideband (UWB) technology, Bluetooth (BT) technology, and other technologies.

In an example embodiment, the device 700 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above method.

In an example embodiment, a non-transitory computer-readable storage medium including instructions is further provided, such as the memory 704 including instructions. The above instructions can be executed by the processor 720 of the device 700 to complete the above method. For example, the non-transitory computer-readable storage medium may be a ROM, a random access memory (RAM), a CD-ROM, a tape, a floppy disk, and an optical data storage device.

### INDUSTRIAL APPLICABILITY

After the user device sends or receives a set message, the main transceiver is kept in an on state for a set time period for downlink channel monitoring. Thus, the main transceiver can be turned on without the need for a wake-up signal to trigger, thereby reducing the dependence on the wake-up signal and improving the active processing capability of the user device.

1. A downlink channel monitoring method, performed by a user device and comprising:
keeping a main transceiver in an on state for a set time period after the user device sends or receives a set message, wherein the on state of the main transceiver corresponds to monitoring of a downlink channel.

2. The downlink channel monitoring method according to claim 1, wherein
keeping the main transceiver in the on state for the set time period after the user device sends or receives the set message, comprises:
in response to the user device receiving or not receiving wake-up information after sending or receiving the set message, keeping the main transceiver in the on state for the set time period.

3. The downlink channel monitoring method according to claim 1, wherein
the set time period corresponds to the set message.

4. The downlink channel monitoring method according to claim 1, wherein
keeping the main transceiver in the on state for the set time period after the user device sends or receives the set message, comprises:
after the user device sends the set message in random access, keeping the main transceiver in the on state for the set time period, wherein the set time period is a first time period.

5. The downlink channel monitoring method according to claim 1, wherein
keeping the main transceiver in the on state for the set time period after the user device sends or receives the set message, comprises:
after the user device sends the set message in four-step random access, keeping the main transceiver in the on state for the set time period, wherein the set message is msg1, and the set time period is a second time period.

6. The downlink channel monitoring method according to claim 1, wherein
keeping the main transceiver in the on state for the set time period after the user device sends or receives the set message, comprises:
after the user device sends the set message in two-step random access, keeping the main transceiver in the on state for the set time period, wherein the set message is msgA, and the set time period is a third time period.

7. The downlink channel monitoring method according to claim 1, wherein
keeping the main transceiver in the on state for the set time period after the user device sends or receives the set message, comprises:
after the user device sends the set message in four-step random access, keeping the main transceiver in the on state for the set time period, wherein the set message is msg3, and the set time period is a fourth time period.

8. The downlink channel monitoring method according to claim 1, wherein
keeping the main transceiver in the on state for the set time period after the user device sends or receives the set message, comprises:
after receiving the set message in a random access triggered by a received paging message, keeping the main transceiver in the on state for the set time period, wherein the set message is msg4 or msgB, and the set time period is a fifth time period.

9. The downlink channel monitoring method according to claim 1, wherein
keeping the main transceiver in the on state for the set time period after the user device sends or receives the set message, comprises:
after receiving the set message in a random access which is triggered by an uplink in an asynchronous state when receiving downlink information, keeping the main transceiver in the on state for the set time period, wherein the set message is msg4 or msgB, and the set time period is a sixth time period.

10. The downlink channel monitoring method according to claim 1, wherein
keeping the main transceiver in the on state for the set time period after the user device sends or receives the set message, comprises:
after sending the set message, keeping the main transceiver in the on state for the set time period, wherein the set message is a Hybrid Automatic Repeat Request acknowledgment (HARQ-ACK) for Physical Downlink Shared Channel (PDSCH) or Downlink Control Information (DCI), the HARQ-ACK indicates negative acknowledgment (NACK), and the set time period is a seventh time period.

11. The downlink channel monitoring method according to claim 1, wherein
keeping the main transceiver in the on state for the set time period after the user device sends or receives the set message, comprises:
after sending the set message, keeping the main transceiver in the on state for the set time period, wherein the set message is a Scheduling Request (SR), and the set time period is an eighth time period.

12. The downlink channel monitoring method according to claim 1, wherein
keeping the main transceiver in the on state for the set time period after the user device sends or receives the set message, comprises:
after sending the set message and indicating uplink data to be transmitted, keeping the main transceiver in the on state for the set time period, wherein the set message is a Buffer Status Report (BSR), the set time period is a ninth time period, and the BSR comprises a Medium Access Control (MAC) layer BSR transmitted on a Physical Uplink Shared Control Channel (PUSCH) or a physical layer BSR transmitted on a Physical Uplink Control Channel (PUCCH).

13. The downlink channel monitoring method according to claim 9, wherein
the set time period does not comprise a time slot or symbol that is semi-statically configured as uplink; or
the set time period comprises at least one of:
time slots or symbols that are semi-statically configured as downlink; or
time slots or symbols that are semi-statically configured as downlink, and symbols that are indicated as downlink by slot form indicator (SFI).

14. (canceled)

15. The downlink channel monitoring method according to claim 1, wherein
keeping the main transceiver in the on state for the set time period after the user device sends or receives the set message, comprises:
after receiving the set message, keeping the main transceiver in the on state for the set time period, wherein the set message is a set DCI, and the set time period is a tenth time period.

16. The downlink channel monitoring method according to claim 15, wherein
the set DCI comprises DCI with Cyclic Redundancy Check (CRC) scrambled by using a Cell-Radio Network Temporary Identifier (C-RNTI), a Configured Scheduling RNTI (CS-RNTI), or a Modulation and Coding Scheme (MCS)-C-RNTI; or
the set DCI does not comprise DCI with CRC scrambled by using Paging RNTI (P-RNTI), System Information RNTI (SI-RNTI), or Random Access RNTI (RA-RNTI).

17. (canceled)

18. The downlink channel monitoring method according to claim 1, wherein
keeping the main transceiver in the on state for the set time period after the user device sends or receives the set message, comprises:
after receiving the set message, keeping the main transceiver in the on state for the set time period, wherein the set message is a PDSCH and the set time period is an eleventh time period.

19. The downlink channel monitoring method according to claim 18, wherein
the PDSCH comprises a PDSCH scheduled by DCI with CRC scrambled by using C-RNTI, CS-RNTI, or MCS-C-RNTI; or
the PDSCH does not comprise a PDSCH without DCI scheduling, and does not comprise a PDSCH scheduled by DCI with CRC scrambled by using SI-RNTI.

20. (canceled)

21. A downlink channel monitoring method according to claim 1, wherein
the set time period is configured by a network device or determined by a protocol; or
a start time of the set time period is an end position of a symbol corresponding to the user device sending or receiving the set message, or an end position of a time slot corresponding to sending of the set message.

22. (canceled)

23. (canceled)

24. A communication device, arranged in a user device and comprising:
a memory, configured to store a computer program; and
a processor, configured to execute the computer program to:
keep a main transceiver in an on state for a set time period after the user device sends or receives a set message, wherein the on state of the main transceiver corresponds to monitoring of a downlink channel.

25. A non-transitory computer-readable storage medium having instructions stored therein, wherein, when the instructions are executed by a processor, the processor is caused to perform:
keeping a main transceiver in an on state for a set time period after a user device sends or receives a set message, wherein the on state of the main transceiver corresponds to monitoring of a downlink channel.
